(19) United States
(12) Patent Application Publication
(10) Pub. No.: US 2019/0034872 A1
(43) Pub. Date: Jan. 31, 2019

(54) System and Method of Automatically Recording Compliance Data for Shipped Pharmaceutical Products Subject to Supply Chain Tracking Regulations

(71) Applicant: James J. Sullivan, Yardley, PA (US)

(72) Inventor: James J. Sullivan, Yardley, PA (US)

(21) Appl. No.: 15/665,414

(22) Filed: Jul. 31, 2017

(51) Int. Cl. G06Q 10/08; G06Q 50/22

(52) U.S. Cl. CPC G06Q 10/0833; G06Q 50/22

(57) ABSTRACT

A system and method of automatically collecting data contained within an EDI file that accompanies a shipment of a regulated pharmaceutical product so as to comply with federal and state regulations. Application software is run by a computer system that automatically reads an incoming EDI file. The application software parses the EDI file in search of trigger attributes that include shipment headlines, order headlines and item headlines. The application software reads shipment data from a first set of attributes that follows said shipment headlines. Likewise, the application software reads order data from a second set of attributes that follows the order headlines and reads item data from a third set of attributes that follows the item headlines. The data collected includes the data required for statutory tracking, such as lot number, expiration date, product name, product manufacturer, and chain of ownership. This data is saved as searchable variables in a database.

### BACKGROUND OF THE INVENTION

### 1. Field of the Invention

In general, the present invention relates to systems, methods and software that are used to track the supply chain of a product between the manufacturer and the consumer. More particularly, the present invention relates to systems, methods and software that are used to track the supply chain of pharmaceutical products that are subject to statutory regulations such as the Drug Supply Chain Security Act.

### 2. Prior Art Description

Pharmaceutical companies manufacture drugs and many other pharmaceutical products. Sometimes a pharmaceutical company may manufacture a product in only one facility. At other times, a pharmaceutical product can be manufactured in multiple facilities around the globe. There are also many instances when a generic pharmaceutical product is manufactured by different pharmaceutical companies in a variety of facilities.

Pharmaceutical companies typically do not sell pharmaceutical products directly to patients. Rather, pharmaceutical companies typically sell pharmaceutical products to local area distributors. The local area distributors than sell the pharmaceutical products to retailers and commercial establishments, such as pharmacies and hospitals. The retailers and hospitals then supply the pharmaceutical products to consumers.

Many pharmaceutical products contain complex compounds that are difficult to manufacture. The potencies of many such pharmaceutical compounds are affected by time and temperature. If a pharmaceutical product expires, or is compromised during manufacture or during transport and storage, then the pharmaceutical product may become unsafe.

Once a pharmaceutical product is identified as unsafe, it must be removed from the chain of commerce. However, this has proven very difficult to do. Information about a particular pharmaceutical product does not always follow the pharmaceutical product along the supply chain. Although a pharmacy or hospital may be able to identify a particular pharmaceutical product in stock, they may not be able to identify all the distributors, wholesalers, and retailers who may have had previous possession of that pharmaceutical product. As such, if it was learned that a certain pharmaceutical product was compromised by being wrongly stored at a distributor, it may not be possible for a pharmacy or hospital to identify if their stock was affected.

This problem was addressed by the Drug Supply Chain Security Act, which mandates the tracking of certain pharmaceutical products throughout the supply chain. Compliance with the Drug Supply Chain Security Act should make it possible to identify and trace pharmaceutical products that have been compromised at some point within the supply chain.

Regulations associated with the Drug Supply Chain Security Act and similar regulations now require that manufacturers, distributors, wholesalers and retailers produce and retain copious numbers of receipts and data for every regulated pharmaceutical product that is bought and sold. These requirements have significantly increased the costs of doing business.

A need therefore exists for a system, method and software that can automatically track and maintain data concerning regulated pharmaceutical products to maintain compliance with the Drug Supply Chain Security Act and similar regulations. In this manner, no time is needed in creating or maintaining paperwork, thus reducing the costs of doing business. This need is met by the present invention as described and claimed below.

### SUMMARY OF THE INVENTION

The present invention is a system and method of automatically collecting data contained within an EDI file that accompanies a shipment of a regulated pharmaceutical product so as to comply with federal and state regulations. Application software is run by a computer system that automatically reads an incoming EDI file. The application software parses the EDI file in search of trigger attributes that include shipment headlines, order headlines and item headlines. The application software reads shipment data from a first set of attributes that follows said shipment headlines. Likewise, the application software reads order data from a second set of attributes that follows the order headlines and reads item data from a third set of attributes that follows the item headlines. The data collected includes the data required for statutory tracking, such as lot number, expiration date, product name, product manufacturer, and chain of ownership.

The application software automatically saves the shipping data, the order data, and the item data as searchable variables in a database accessed by the computer system.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic view of an exemplary supply chain for a regulated pharmaceutical product;

FIG. 2 is a schematic showing the primary components of the present invention system;

FIG. 3 shows an exemplary segment of an EDI file; and

FIG. 4 is a flow chart showing an exemplary method of operation.

### DETAILED DESCRIPTION OF THE DRAWINGS

The present invention system, method and software of automatically obtaining and maintaining supply chain data regarding pharmaceutical products can be accomplished in different ways using different programming languages and protocols. An exemplary embodiment has been selected for the purposes of description and understanding. The embodiment is selected in order to set forth one of the best modes contemplated for the invention. The illustrated embodiment, however, is merely exemplary and should not be considered a limitation when interpreting the scope of the appended claims.

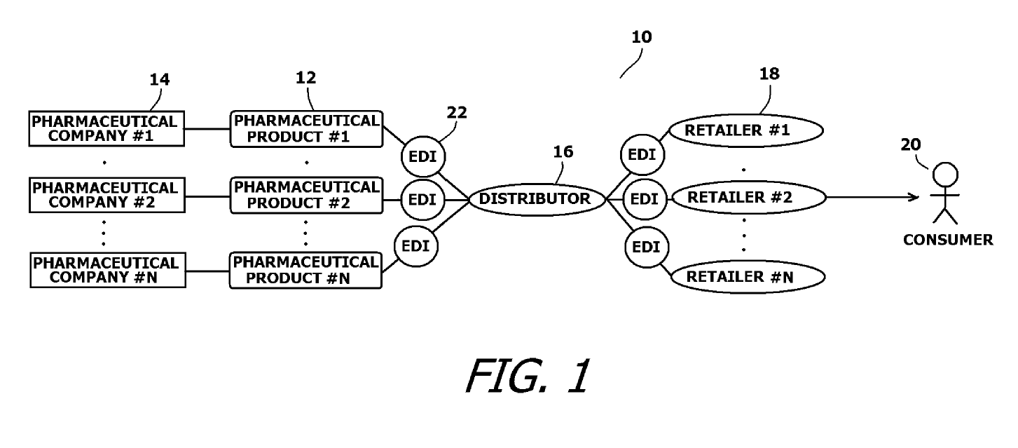

Referring to FIG. 1, an exemplary supply chain 10 is illustrated for pharmaceutical products 12, including those pharmaceutical products subject to the Drug Supply Chain Security Act. Shown in FIG. 1 is a plurality of pharmaceutical manufacturing companies 14. The pharmaceutical manufacturing companies 14 may make one or more regulated pharmaceutical products 12. Orders for one or more of those pharmaceutical products 12 are placed by regional distributors 16, wholesalers, repackagers and the like. The regional distributors 16 receive orders from retailers 18, such as pharmacies and hospitals. The retailers 18 supply the pharmaceutical products 12 to individual patients 20.

Each time an order is filled in the supply chain 10 by a pharmaceutical company 14 or a distributor 16, an electronic data interchange (EDI) file 22 is generated. The National Institute of Standards and Technology defines an electronic data interchange (EDI) as “the computer-to-computer interchange of strictly formatted messages that represent documents other than monetary instruments”. EDI files 22 are more than a mere electronic communication or data exchange, such as an e-mail or text message. Rather, in the EDI file 22, the usual processing of received messages is by computer only. That is, the EDI file 22 being transmitted is not normally intended for human interpretation as part of online data processing. Accordingly, EDI files 22 are used for the transfer of structured data, by agreed message standards, from one computer system to another without human intervention.

By adhering to the same EDI file standards, two different companies or organizations, can electronically exchange documents, such as purchase orders and shipping notices. There are many EDI file standards such as X12, EDIFACT®, ODETTE®. In the pharmaceutical industry, the EDI file standard is typically X12, which is also known as Accredited Standard Committee X12 or ASC X12.

Each time a pharmaceutical order is prepared and shipped, it is accompanied with a corresponding EDI file 22. The shipper of the order prepares the EDI file 22 as an outgoing file and the receiver of the order receives the EDI file 22 as an incoming file.

In FIG. 1, only one distributor 16 is shown in the supply chain 10. It will be understood that there may be several distributors, wholesalers and repackaging companies in the supply chain 10 and the showing of one distributor is a mere convenience. The distributor 16 in the exemplary supply chain 10 receives incoming EDI files 22 with incoming orders and produces outgoing EDI files 22A with outgoing orders.

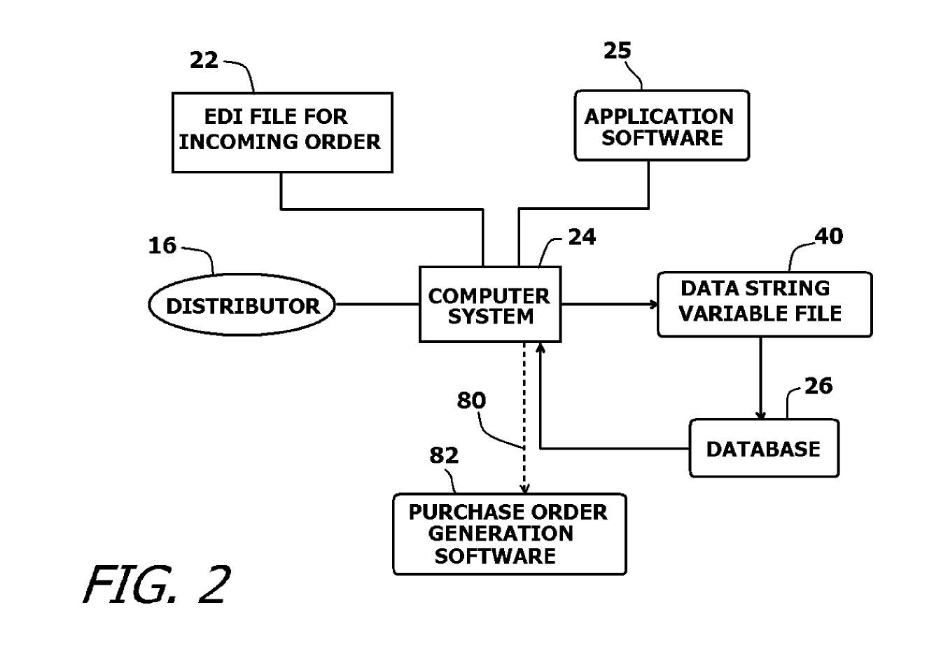

Referring to FIG. 2 in conjunction with FIG. 1, it will be understood that the distributor 16 has a computer system 24. The computer system 24 may be a computer that is housed at the distributor 16 or an on-line system that the distributor accesses via a network, such as the Worldwide Web. The computer system 24 receives an incoming EDI file 22, each time the distributor 16 receives an incoming order. Application software 25 is loaded onto the computer system 24 of the distributor 16. The application software 25 automatically reads an incoming EDI file addressed to the computer system 24. The application software 25 reads the EDI file 22 and extracts specific data that is required to comply with statutory regulations such as the Drug Supply Chain Security Act (DSCSA) or any similar regulation that may come in its place. This compliance data is stored in a compliance database 26. The compliance database 26 is automatically updated each time an incoming EDI file 22 is received. The compliance database 26 can be easily searched and otherwise referenced should the supply chain of a particular pharmaceutical product 12 need to be traced. Likewise, the compliance database 26 is available to any government agency checking for statutory compliance with the Drug Supply Chain Security Act.

When the distributor 16 receives an order, the order is accompanied with an EDI file 22. The received order may, and often does, contain numerous different pharmaceutical products that have followed varied supply chains. To maintain, DSCSA compliance, information about each regulated pharmaceutical product 12 must be obtained from the EDI file 22. This retrieved information includes shipping information, order information and product information. The shipping information includes purchase order information and the upstream supply chain information. The order information includes the invoice number and the purchase order for the shipment. The product information includes basic information about the pharmaceutical product, such as generic name, trade name, national drug code, package dosage, expiration date and the like.

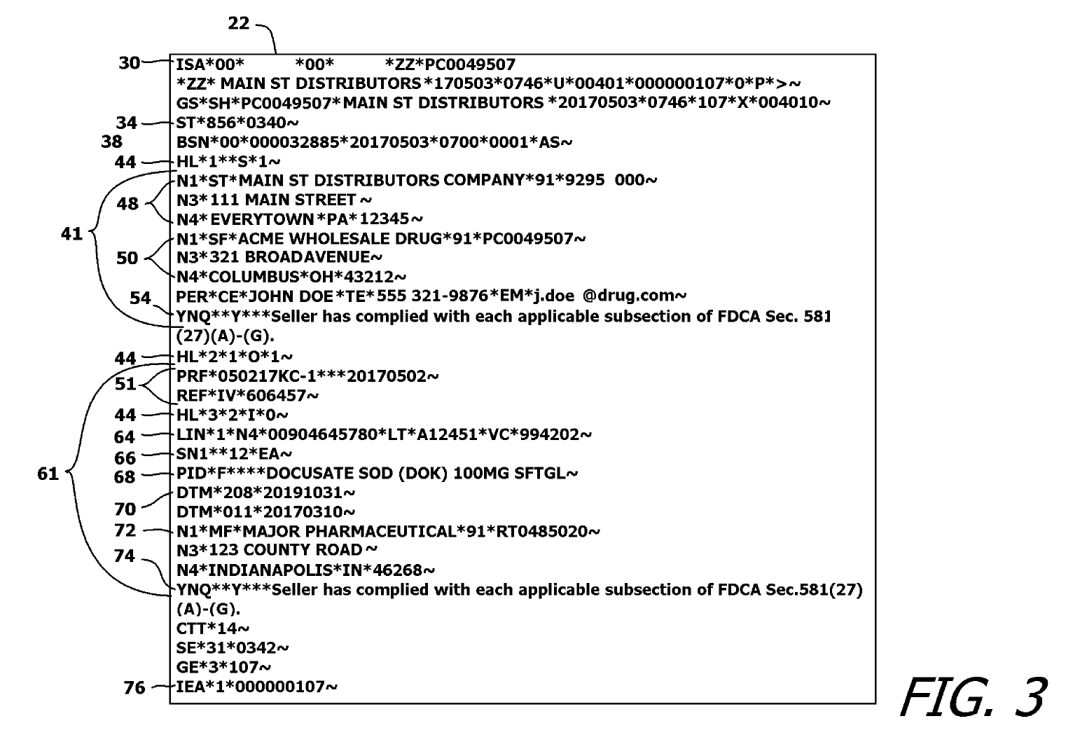

In FIG. 3, an exemplary portion of an incoming EDI file 22 is shown. Referring to FIG. 3 in conjunction with FIG. 2, it will be understood that the EDI file 22 is intended to be read directly by a computer system 24 and is not to be directly read by a person. As such, the EDI file 22 is written and formatted in a computer data language used for EDI files, such as ASC X12 in the present example. In the example provided, it is assumed that the distributor 16 receives an order for pharmaceutical products subject to the Drug Supply Chain Security Act. The pharmaceutical products were received from a wholesaler in an order that was accompanied with an incoming EDI file 22.

The incoming EDI file 22 is read using the application software 25. The application software 25 searches for trigger attributes in the incoming EDI file 22. The trigger attributes are used to identify data strings that are collected into a data string variable file 40 stored within the compliance database 26. The EDI file 22 contains a great deal of superfluous information in addition to the data strings that are needed to be collected. The superfluous information is avoided by keying on only the data lines in the EDI file 22 that are identified with the trigger attributes coded into the application software 25.

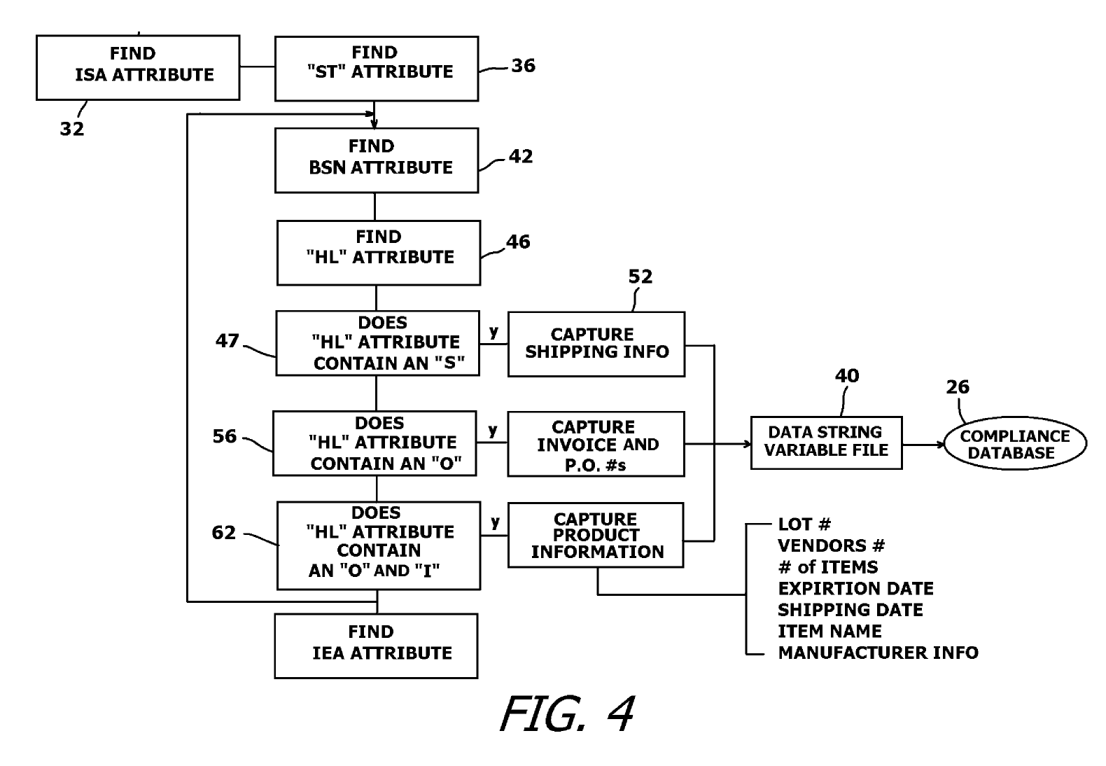

Referring to FIG. 4 in conjunction with FIG. 3 and FIG. 2, the methodology of the application software 25 is explained. In reading the incoming EDI file 22, the ISA attribute 30 is first identified. See Block 32. The ISA attribute 30 is used as a marker to indicate when parsing of the EDI file 22 by the software application 25 should begin. Once parsing begins, the application software 25 searches for an ST attribute 34. See Block 36. The ST attribute 34 indicates when order information on the EDI file 22 is about to start. The ST attribute 34 is used to set a flag within the software application 25 so that subsequent information is to be recorded as variable in a data string variable file 40 within the compliance database 26. The parsing continues until it reaches a stop attribute in the EDI file 22.

After the ST attribute 34 is identified, parsing begins to look for specific target attributes. When a specific target attribute is located in the EDI file 22, the data that follows the target attribute is added to the data string variable file 40. After the ST attribute 34, the second targeted attribute of the software application 25 is the BSN attribute 38. See Block 42. The data following the BSN attribute 38 indicates the date of the shipment for which the incoming EDI file 22 was made. This data is saved as a variable in the data string variable file 40.

The software application 25 then begins to parse for headline (HL) attributes 44. See Block 46. There are different subsets of headline attributes 44. A first HL subset 41 is for headline attribute 44 that contains an “S” in the attribute chain, such as the example attribute HL*1**S*1˜. This indicates that the headline attribute 44 is followed by information concerning the shipment recipient and the shipments originator. See Block 47. After a headline attribute 44 with an “S” in the attribute chain, there are a variety of “N” attributes 48, 50 in the HL subset 41. The N attributes 48, 50 identify shipping information for capture. See Block 52. A first set of N attributes 48 identify the name and address of the order recipient. A second set of N attributes 50 identify the name and address of the shipment originator. The data corresponding to the shipment recipient and the shipment originator are saved as variables in the data string variable file 40.

After the N attributes 48, 50 identifying the shipper and the recipient, there is a YNQ attribute 54 that clears the flag and stops parsing until another headline attribute 44 is encountered. This ends the HL subset 41.

A second HL subset 51 begins parsing for a headline attribute 44 that contains an “O”. If the parsing of the EDI file 22 finds a headline attribute 44 that contains an “O” attribute chain, such as the example attribute HL*2*1*O*1˜, then order data is to follow. See Block 56. The headline attribute 44 that contains an “O” in its attribute chain is followed by a PRF attribute 58 and an REF attribute 60. The PRF attribute 58 and the REF attribute 60 contain data corresponding to the invoice number and the purchase order number of the shipment for which the EDI file 22 is made. This ends the second Hl subset 51. This data is saved as variables in the data string variable file 40.

A third HL subset 61 begins when a headline attribute is found that contains both an “O” and an “I”. If the parsing of the EDI file 22 finds a headline attribute 44 that contains an “I” attribute in the attribute chain, such as the example attribute HL*3*2*I*0˜, then data concerning one particular pharmaceutical product being shipped is to follow. See Block 62. After a headline attribute 44 with an “I” in the attribute chain, there is a LIN attribute 64 on the Hl subset 61. The LIN attribute 64 contains a data string that identifies the item by its national drug code, the lot number and the item number of the shipper, vendor's catalog number. This data is saved as variables in the data string variable file 40 in the compliance database 26. The LIN attribute 64 is typically followed by an SN1 attribute 66. The SN1 attribute 66 contains a data string that identifies the quantity of the pharmaceutical product being shipped. This data is saved as variables in the data string variable file 40 in the compliance database 26.

In the HL subset 61, the software application 25 will also identify a PID attribute 68. The PID attribute 68 is a product item description attribute and contains a data string that identifies the trade name of the pharmaceutical product. This data is saved as a variable in the data string variable file 40 in the compliance database 26.

The software application 25 will identify a DTM*208 attribute 70 in the HL subset 61. The DTM*208 attribute 70 is used to identify the expiration data for the lot number in the data string of the prior LIN attribute 64. This data is saved as a variable in the data string variable file 40 in the compliance database 26.

An N1*mf attribute 72 is also contained in the HL subset 61. The N1*mf attribute 72 identifies the source manufacturer of the pharmaceutical product 12. Subsequent N attributes 73 identify the address of that source manufacturer. The headline subset 61 ends with a YNQ attribute 74 that closes the HL subset 61.

If multiple pharmaceutical products are shipped together in one order, as is often the case, then the EDI file 22 will contain different headline attributes that contain an “I” in the attribute chain. Each such subset will provide data corresponding to a different pharmaceutical product. The process is repeated for each order and each item in each order that is contained within the EDI file 22. The process ends when an IEA attribute 76 is found. The IEA attribute 76 only occurs at the end of the EDI file 22.

From the above, it will be understood that the application software 25 collects data for each product's invoice, purchase order, national drug code, lot number, vendor's catalog number, the number of items shipped, the item description (name), the item's lot expiration, the shipping date, and manufacture information. Also recorded is the name and address of the current recipient of the product and the name and address of the previous shippers of the product. All of this information is stored as variables in a data string variable file 22 stored within the compliance database 26. This information can be searched and retrieved in many different ways including creating DSCSA compliance reports.

In addition, as indicated by line 80, the application software 25 can interact with existing purchase order generation software 82 utilized by a manufacturer, distributor or retailer in the supply chain. Data can be retrieved from the compliance database 26 to more efficiently generate EDI files to accompany any new outgoing order.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of automatically collecting data contained within an EDI file that accompanies a shipment of a regulated pharmaceutical product, said method comprising the steps of:
running application software in a computer system that automatically reads said EDI file and parses said EDI file in search of shipment headlines, order headlines and item headlines, wherein said application software reads shipment data from a first set of attributes that follow said shipment headlines, reads order data from a second set of attributes that follows said order headlines and reads item data from a third set of attributes that follows said item headlines;
wherein said application software automatically saves said shipping data, said order data and said item data as searchable variables in a database accessible by said computer system.

2. The method according to claim 1, wherein said shipment data includes a name and address for a recipient of the regulated pharmaceutical product when last shipped.

3. The method according to claim 1, wherein said shipment data includes names and addresses of entities who have previously shipped said regulated pharmaceutical product.

4. The method according to claim 1, wherein said order information includes an invoice number and a purchase order number.

5. The method according to claim 1, wherein said item information includes a product name and lot number for said regulated pharmaceutical product.

6. The method according to claim 1, wherein said item information includes an expiration date for said regulated pharmaceutical product.

7. The method according to claim 1, wherein said item information includes information identifying a manufacturer of said regulated pharmaceutical product.

8. The method according to claim 1, further including accessing said database to acquire data needed to create a new EDI file when shipping said regulated pharmaceutical product to another.

9. A method of documenting compliance with supply chain tracking requirements for shipments of a regulated pharmaceutical product accompanied with an EDI file shipping order, said method comprising the steps of:
reading said EDI file into a computer running application software that automatically captures data from said EDI file, wherein said application software parses said EDI file for shipment subsets, order subsets and item subsets;
wherein said application software reads shipment data from a first set of attributes within said shipment subsets, reads order data from a second set of attributes within said order subsets and reads item data from a third set of attributes within said item subsets;
wherein said application software automatically saves said shipment data, said order data and said item data as searchable variables in a database accessible by said computer.

10. The method according to claim 9, wherein said shipment data includes a name and an address for a recipient of the regulated pharmaceutical product when last shipped.

11. The method according to claim 9, wherein said shipment data includes names and addresses of entities who have previously shipped said regulated pharmaceutical product.

12. The method according to claim 9, wherein said order data includes an invoice number and a purchase order number.

13. The method according to claim 9, wherein said item data includes a product name and lot number for said regulated pharmaceutical product.

14. The method according to claim 9, wherein said item data includes an expiration date for said regulated pharmaceutical product.

15. The method according to claim 9, wherein said item data includes information identifying a manufacturer of said regulated pharmaceutical product.

16. The method according to claim 9, further including accessing said database to acquire data needed to create a new EDI file when shipping said regulated pharmaceutical product to another.

17. A system that automatically collects data contained within an EDI file that accompanies a shipment of a regulated pharmaceutical product, said system comprising:
a computer system that automatically reads said EDI file and parses said EDI file in search of shipment headlines, order headlines and item headlines, wherein said computer system reads shipment data from a first set of attributes that follow said shipment headlines, reads order data from a second set of attributes that follows said order headlines and reads item data from a third set of attributes that follows said item headlines;
wherein said computer system automatically saves said shipping data, said order data and said item data as searchable variables in a database.

18. The system according to claim 17, wherein said shipment data includes a name and an address for a recipient of the regulated pharmaceutical product when last shipped.

19. The system according to claim 17, wherein said item data includes a product name and a lot number for said regulated pharmaceutical product.

20. The system according to claim 17, wherein said item data includes an expiration date for said regulated pharmaceutical product.
